(19) United States
(12) Patent Application Publication
(10) Pub. No.: US 2026/0288567 A1
(43) Pub. Date: Sep. 24, 2026

(54) MANAGEMENT SUPPORT DEVICE, MANAGEMENT SUPPORT METHOD, AND RECORDING MEDIUM

(71) Applicant: NEC Corporation, Tokyo (JP)

(72) Inventor: Tomoki MIYAZAWA, Tokyo (JP)

(73) Assignee: NEC Corporation, Tokyo (JP)

(21) Appl. No.: 19/454,529

(22) Filed: Jan. 21, 2026

(30) Foreign Application Priority Data
Mar. 19, 2025 (JP) 2025-045875

(51) Int. Cl. G06F 11/07

(52) U.S. Cl. CPC G06F 11/079; G06F 11/0709

(57) ABSTRACT

A management support device includes a generation unit, a target component information acquisition unit, and a target determination unit. The generation unit generates difference information indicating a difference between configuration information that is information indicating a component constituting an information system and determination result information indicating a result of determination as to whether the component is included in the information system. The target component information acquisition unit acquires information indicating a component that needs to be examined as target component information. The target determination unit determines an information system including the component indicated by the target component information based on the configuration information and the difference information.

This application is based upon and claims the benefit of priority from Japanese Patent Application No. 2025-45875, filed on Mar. 19, 2025, the disclosure of which is incorporated herein in its entirety by reference.

### TECHNICAL FIELD

The present disclosure relates to a management support device and the like.

### BACKGROUND ART

An information system may be used to identify an information system that requires action against vulnerability of a component.

A vulnerability management system of JP 2020-21309 A generates information indicating a product that is a target to be examined for an influence of vulnerability of software based on a database that collects configuration information of the software included in the product. Then, the vulnerability management system of JP 2020-21309 A examines the influence of the vulnerability of software in the target product.

### SUMMARY

An object of the present disclosure is to provide a management support device and the like capable of improving accuracy of determining a target to be examined even when configuration information is inaccurate.

A management support device according to an aspect of the present disclosure includes a generation unit that generates difference information indicating a difference between configuration information that is information indicating a component constituting an information system and determination result information indicating a result of determining whether the component is included in the information system, a target component information acquisition unit that acquires information indicating a component that needs to be examined as target component information, and a target determination unit that determines the information system including the component indicated by the target component information based on the configuration information and the difference information.

A management support method according to an aspect of the present disclosure includes generating difference information indicating a difference between configuration information that is information indicating a component constituting an information system and determination result information indicating a result of determining whether the component is included in the information system, acquiring information indicating a component that needs to be examined as target component information, and determining the information system including the component indicated by the target component information based on the configuration information and the difference information.

A non-transitory recording medium according to an aspect of the present disclosure records a program for causing a computer to execute processing of generating difference information indicating a difference between configuration information that is information indicating a component constituting an information system and determination result information indicating a result of determining whether the component is included in the information system, processing of acquiring information indicating a component that needs to be examined as target component information, and processing of determining the information system including the component indicated by the target component information based on the configuration information and the difference information.

### BRIEF DESCRIPTION OF THE DRAWINGS

Exemplary features and advantages of the present invention will become apparent from the following detailed description when taken with the accompanying drawings in which:

FIG. 1 is a diagram illustrating an example of a configuration of an information management system in an example embodiment of the present disclosure;

FIG. 2 is a diagram illustrating an example of a configuration of a management support device in the example embodiment of the present disclosure;

FIG. 3 is a view illustrating an example of configuration information in the example embodiment of the present disclosure;

FIG. 4 is a view illustrating an example of information regarding a component in the example embodiment of the present disclosure;

FIG. 5 is a view illustrating an example of information on a relationship between an information system and the component in the example embodiment of the present disclosure;

FIG. 6 is a view illustrating an example of detection result information in the example embodiment of the present disclosure;

FIG. 7 is a view illustrating an example of difference information in the example embodiment of the present disclosure;

FIG. 8 is a view illustrating an example of target component information in the example embodiment of the present disclosure;

FIG. 9 is a view illustrating an example of a determination result as to whether examination is necessary in the example embodiment of the present disclosure;

FIG. 10 is a view illustrating an example of the determination result as to whether examination is necessary in the example embodiment of the present disclosure;

FIG. 11 is a view illustrating an example of an operation flow of the management support device in the example embodiment of the present disclosure;

FIG. 12 is a view illustrating an example of an operation flow of the management support device in the example embodiment of the present disclosure;

FIG. 13 is a view illustrating an example of a determination criterion in the example embodiment of the present disclosure;

FIG. 14 is a view illustrating an example of an operation flow of the management support device in the example embodiment of the present disclosure;

FIG. 15 is a view illustrating an example of the operation flow of the management support device in the example embodiment of the present disclosure;

FIG. 16 is a view illustrating an example of a table illustrating a correspondence relationship between a collation result and the difference information, and necessity of examination in the example embodiment of the present disclosure;

FIG. 17 is a view illustrating an example of the configuration information in the example embodiment of the present disclosure;

FIG. 18 is a view illustrating an example of target component information in the example embodiment of the present disclosure;

FIG. 19 is a view illustrating an example of determination result information in the example embodiment of the present disclosure; and

FIG. 20 is a diagram illustrating an example of a configuration of hardware of the management support device in the example embodiment of the present disclosure.

### EXAMPLE EMBODIMENT

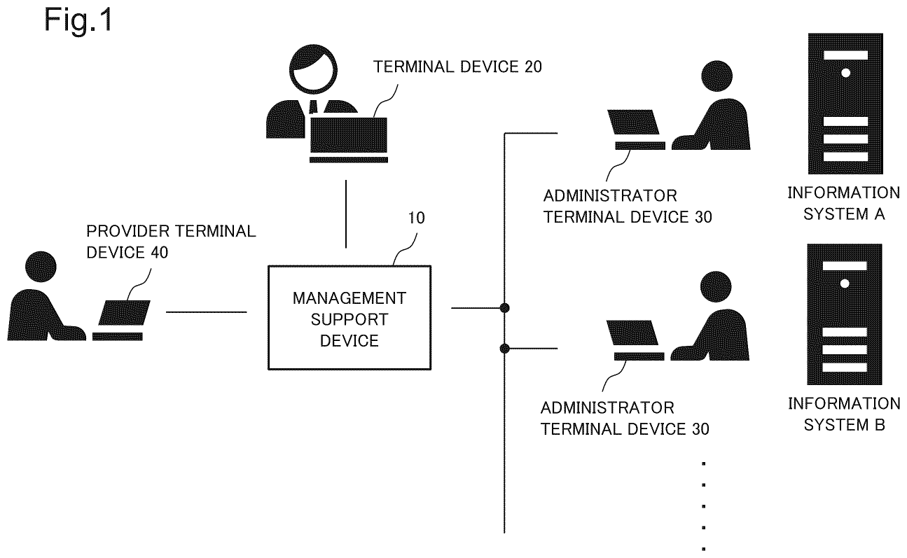

Example embodiments of the present disclosure will be described in detail with reference to the drawings. FIG. 1 is a diagram illustrating an example of a configuration of an information management system. The information management system includes, for example, a management support device 10, a terminal device 20, an administrator terminal device 30, and a provider terminal device 40. The management support device 10 is connected to the terminal device 20 via, for example, a network. The management support device 10 is connected to the administrator terminal device 30 via, for example, a network. The management support device 10 is connected to the provider terminal device 40 via, for example, a network. The numbers of the terminal devices 20, the administrator terminal devices 30, and the provider terminal devices 40 may be plural. The numbers of the terminal devices 20, the administrator terminal devices 30, and the provider terminal devices 40 can be appropriately set.

For example, the information management system determines whether to present an information system including a component indicated by target component information based on configuration information. The configuration information is information indicating the component constituting the information system. The information management system performs management using, for example, the configuration information that is information indicating the component constituting the information system. For example, a software bill of materials (SBOM) is used as the configuration information.

A target component that is a component indicated by target component information is, for example, a component that needs to be determined whether it is used in an information system. For example, the target component is a component having a vulnerability. In a case where the target component is a component having a vulnerability, for example, in an information system in which the component having the vulnerability is used, it is necessary to replace the component having the vulnerability with a component for which countermeasures against the vulnerability have been completed. In such a case, whether action is required in the information system is determined, for example, with reference to configuration information associated with the information system. However, in a case where the configuration information has not been updated or the like, for example, the configuration information does not match a component actually used in the information system, so that it may be impossible to correctly determine whether action is required in the information system. In this manner, in a case where there is a case where the configuration information is inaccurate, it may be necessary to determine whether the information system including the target component may be determined based on the configuration information.

For example, the information management system determines, based on the configuration information, whether to present the information system including the target component based on difference information. The difference information is, for example, information indicating the likelihood that the component is included in the configuration information. The difference information is generated, for example, based on results of action against the component having the vulnerability taken in the information system. Since whether examination is necessary in the information system is determined using the difference information in this manner, accuracy of determining a target to be examined can be improved, for example, even when the configuration information is inaccurate.

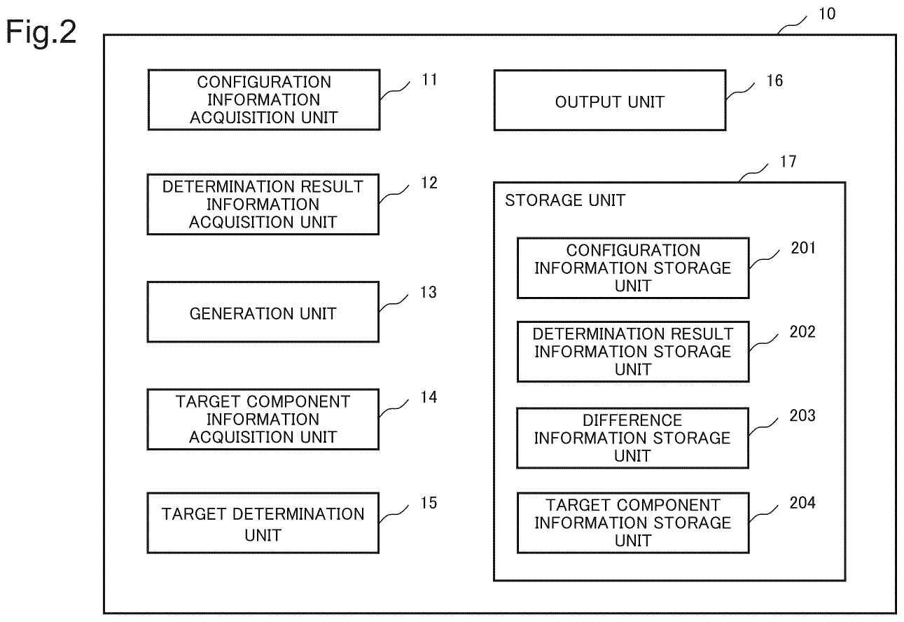

Here, an example of a configuration of the management support device 10 will be described. FIG. 2 is a diagram illustrating an example of a configuration of the management support device 10. The management support device 10 includes, as a basic configuration, a configuration information acquisition unit 11, a determination result information acquisition unit 12, a generation unit 13, a target component information acquisition unit 14, and a target determination unit 15. The management support device 10 further includes, for example, an output unit 16 and a storage unit 17.

The configuration information acquisition unit 11 acquires configuration information that is information indicating a component constituting an information system. The configuration information includes, for example, information identifying the component used in the information system. The configuration information is, for example, information in which the information system is associated with the component constituting the information system. The configuration information includes, for example, an identifier and version information of the component used in the information system. The configuration information acquisition unit 11 acquires, for example, an SBOM as the configuration information.

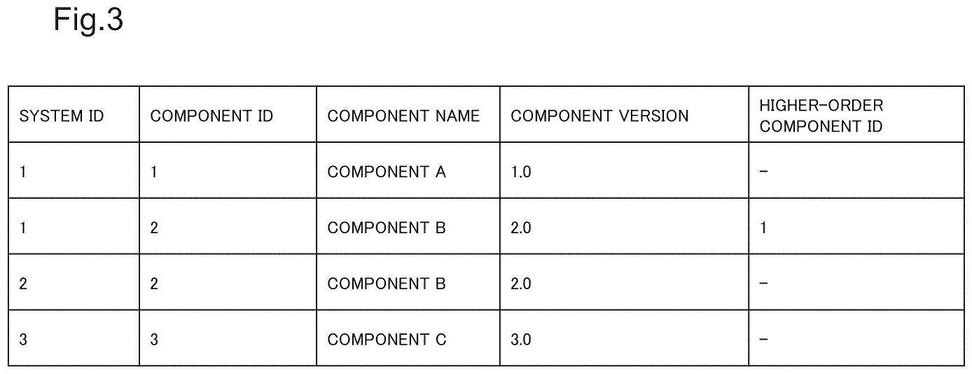

FIG. 3 is an example of the configuration information. In the example of the configuration information of FIG. 3, a system ID, a component ID, a component name, a component version, and a higher-order component ID are associated with each other. In the example of the configuration information of FIG. 3, the system ID is, for example, an identifier allocated to the information system. In the example of the configuration information of FIG. 3, the component ID is, for example, an identifier allocated to the component. In the example of the configuration information of FIG. 3, the component name is, for example, a name of the component. In the example of the configuration information of FIG. 3, the component version is, for example, a version of the component. In the example of the configuration information of FIG. 3, the higher-order component ID is, for example, an identifier of a higher-order component.

In the example of the configuration information of FIG. 3, an information system whose system ID is 1 includes, for example, a component whose component ID is 2 and a component whose component ID is 1, which is a higher-order component of the component whose component ID is 2. In the example of the configuration information of FIG. 3, an information system whose system ID is 2 includes, for example, the component whose component ID is 2. In addition, in the example of the configuration information of FIG. 3, an information system whose system ID is 3 includes, for example, a component whose component ID is 3.

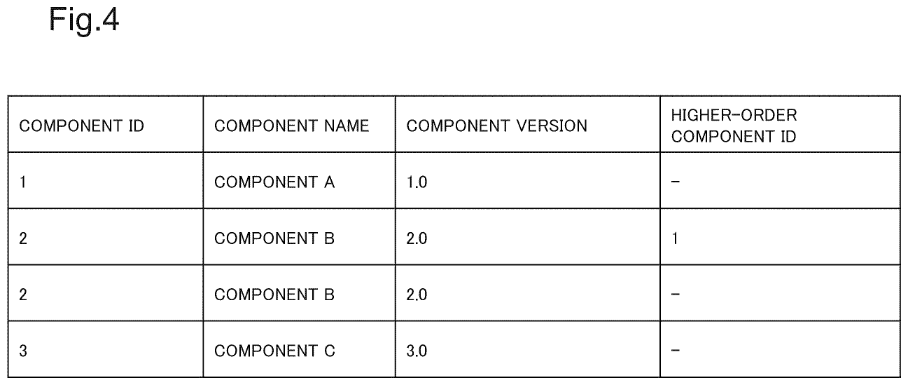

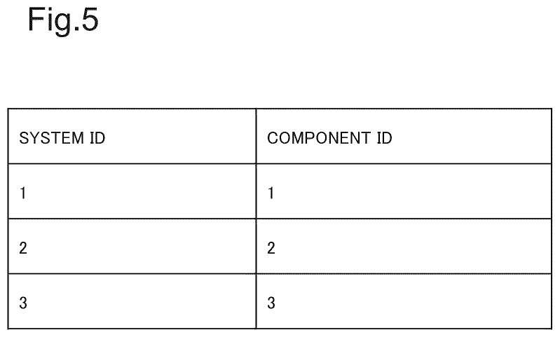

FIG. 4 is an example of information regarding the components used for generating the example of the configuration information of FIG. 3. In the example of FIG. 4, the component ID, the component name, the component version, and the higher-order component ID are associated with each other. In addition, FIG. 5 is an example of information indicating a relationship between each of the information systems used to generate the example of the configuration information of FIG. 3 and each of the components. In the example of FIG. 5, the system ID and the component ID are associated with each other. The example of FIG. 5 is, for example, information indicating a correspondence relationship between an information system and a component constituting the information system. The configuration information acquisition unit 11 may generate the configuration information by acquiring the information regarding the components as in the example of FIG. 4 and the information indicating the relationship between each of the information systems and each of the components as in the example of FIG. 5.

The determination result information acquisition unit 12 acquires determination result information that is information of a result of determining a component included in an information system. For example, the determination result information acquisition unit 12 acquires, as the determination result information, information indicating content of action against a vulnerability in each of the information systems.

The determination result information includes, for example, information on an identifier and a version of a component for which action against the vulnerability has been taken by an administrator of each of the

Information systems. The component for which action has been taken against the vulnerability is a component used in an information system in which action against the vulnerability has been taken. That is, the determination result information is, for example, information indicating a component actually constituting the information system.

The determination result information is, for example, information indicating a determination result as to whether a component included in configuration information actually constitutes an information system. The determination result information includes, for example, information indicating a component that is included in the configuration information but has not been used as the component constituting the information system as a result of taking action against the vulnerability. In addition, the determination result information includes, for example, information indicating a component that is not included in the configuration information but has been used as the component constituting the information system as a result of taking action against the vulnerability.

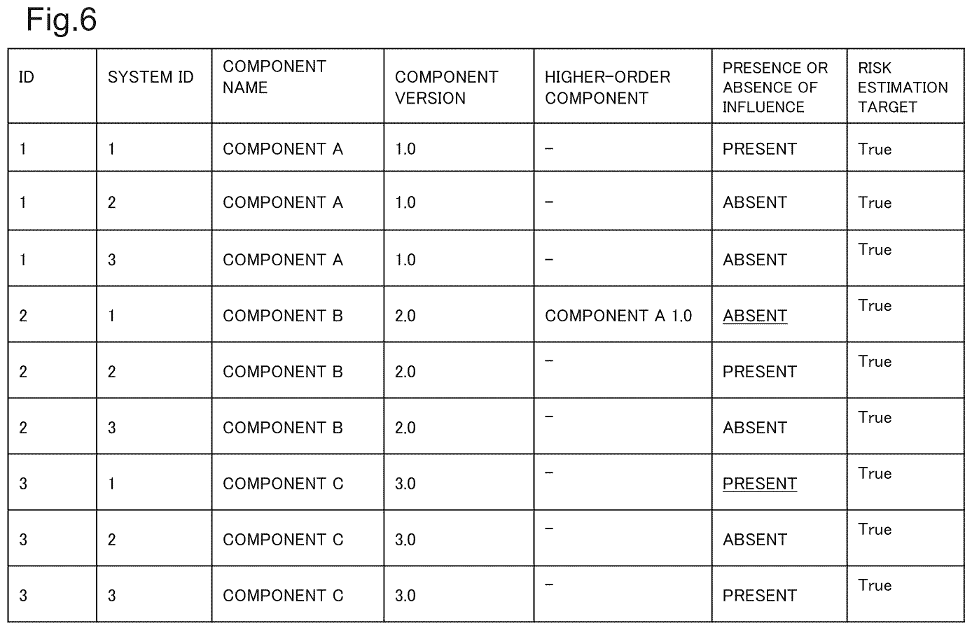

FIG. 6 is an example of the determination result information. In the example of the determination result information in FIG. 6, an ID, a system ID, a component name, a component version, and a higher-order component are associated with presence or absence of an influence and a risk estimation target. In the example of FIG. 6, the ID is, for example, an identifier allocated to each component in vulnerability information. In the example of FIG. 6, the system ID is, for example, an identifier allocated to an information system. In the example of FIG. 6, the component ID is, for example, an identifier allocated to the component. In the example of FIG. 6, the component name is, for example, a name of the component. In the example of FIG. 6, the component version is, for example, a version of the component. In the example of FIG. 6, the higher-order component is, for example, a name and a version of a higher-order component.

In the example of FIG. 6, the presence or absence of the influence is, for example, a result of determination on an influence of the component included in the vulnerability information with respect to the information system by the administrator of the information system. In the example of FIG. 6, the fact that the item of the presence or absence of the influence is “Present” indicates, for example, that the administrator has determined that the vulnerability of the component affects the information system. Alternatively, in the example of FIG. 6, the fact that the item of the presence or absence of the influence is “Present” indicates, for example, that the administrator has determined that the component is included in the information system. In the example of FIG. 6, the fact that the item of the presence or absence of the influence is “Absent” indicates, for example, that the administrator has determined that the vulnerability of the component does not affect the information system. In the example of FIG. 6, the fact that the item of the presence or absence of the influence is “Absent” indicates, for example, that the administrator has determined that the component is not included in the information system. In the example of FIG. 6, for example, the underline in the presence or absence of the influence indicates that a determination result by the administrator is inconsistent with the configuration information. In the example of FIG. 6, the risk estimation target indicates, for example, whether data is a target of risk estimation in generation of difference information to be described later. In the example of FIG. 6, the fact that an item of the risk estimation target is “True” indicates, for example, that data is the target of risk estimation in the generation of difference information. In the example of FIG. 6, in a case where the item of the risk estimation target is “False”, it indicates that the data is not data as the target of risk estimation in the generation of difference information.

The generation unit 13 generates difference information indicating a difference between the configuration information and the determination result information. For example, the generation unit 13 generates, as the difference information, information in which the number of responses, an over-detection risk, and a detection miss risk are associated with each other for each component. The difference between the configuration information and the determination result information is, for example, a difference between a component indicated in the SBOM to constitute the information system and a component for which action has been taken against the vulnerability and is highly likely to actually constitute the information system. The number of responses is, for example, the number of pieces of data registered as results of examination on the presence or absence of the influence of the target component with respect to the information system performed by the administrator. In addition, the number of responses may be a numerical value obtained by excluding the number of pieces of data determined based on the configuration information as to whether the target component is included in the information system.

Over-detection means that, for example, in a case where an information system including a component is detected based on configuration information, an information system not including the component is detected as the information system including the component. The over-detection may occur, for example, as the component that is not actually included in the information system is included in the configuration information. In addition, a detection miss means that, for example, in a case where an information system including a component is detected based on configuration information, an information system including the component is not detected as the information system including the component. The detection miss may occur, for example, as the component actually included in the information system is not included in the configuration information. That is, the over-detection and the detection miss are caused by, for example, uncertainty of the configuration information.

The over-detection risk is, for example, an index indicating a possibility of occurrence of over-detection in a case where an information system including a component is detected based on configuration information. The over-detection risk is calculated, for example, as the number of pieces of data determined as the over-detection with respect to the number of responses, which is the number of pieces of data of determination results used to generate the difference information. In addition, the detection miss risk is, for example, an index indicating a possibility of occurrence of detection miss in a case where an information system including a component is detected based on configuration information. The detection miss risk is calculated, for example, as the number of pieces of data determined as the detection miss with respect to the number of responses which is the number of pieces of data of the determination results used to generate the difference information. In such a case, the difference information including the information on the over-detection risk and the detection miss risk is, for example, accuracy information indicating accuracy of the configuration information.

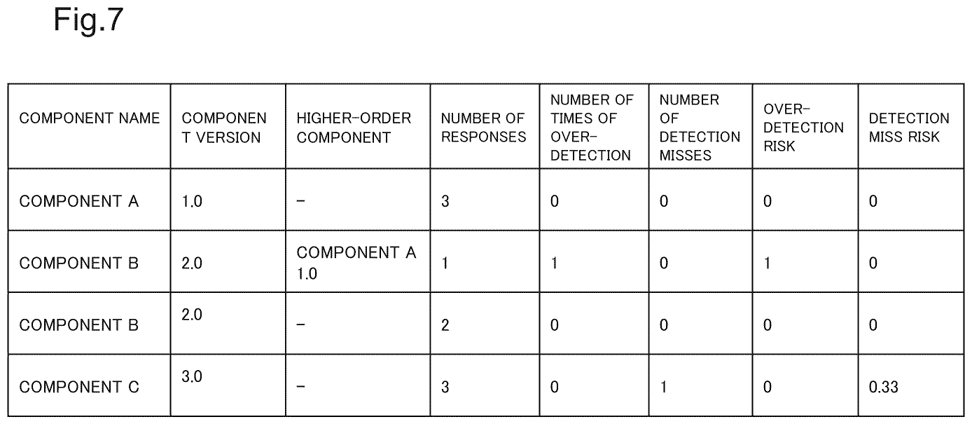

FIG. 7 is an example of generation results of the difference information. In the example of FIG. 7, a component name, a component version, a higher-order component, the number of responses, the number of times of over-detection, the number of detection misses, an over-detection risk, and a detection miss risk are associated with each other. In the example of FIG. 7, the component name is, for example, a name of a target component for which the difference information is generated. In the example of FIG. 7, the component version is, for example, a version of the target component for which the difference information is generated. In the example of FIG. 7, the higher-order component is, for example, a name of a higher-order component of the target component for which the difference information is generated. In the example of FIG. 7, the number of responses is, for example, the number of pieces of data of determination results used to generate the difference information. In the example of FIG. 7, the number of times of over-detection is, for example, the number of pieces of data determined as over-detection in determination results. In the example of FIG. 7, the number of detection misses is, for example, the number of pieces of data determined as detection misses in the determination results. In the example of FIG. 7, the over-detection risk is, for example, a ratio of the number of times of over-detection to the number of responses. In the example of FIG. 7, the detection miss risk is, for example, a ratio of the number of detection misses to the number of responses. In addition, information included in the difference information is not limited to pieces of information of items illustrated in the example of FIG. 7.

The target component information acquisition unit 14 acquires, for example, information indicating a component that needs to be examined as target component information. For example, the target component information acquisition unit 14 acquires, as the target component information, information indicating a component that needs to be examined for a vulnerability in an information system. The target component information is, for example, information identifying the component that needs to be examined for the vulnerability. For example, the information identifying the component that needs to be examined for the vulnerability is an identifier and a version of the component that needs to be examined for the vulnerability. The information identifying the component that needs to be examined for the vulnerability is not limited to the above. In addition, the component that needs to be examined for the vulnerability is, for example, a component whose vulnerability has been confirmed by a supplier or developer of the component.

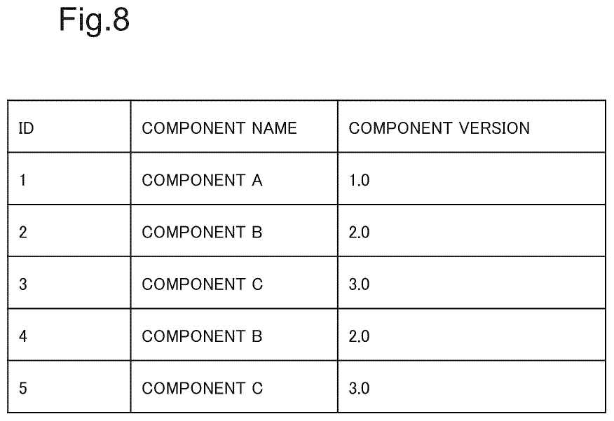

FIG. 8 is an example of the target component information. In the example of the target component information in FIG. 8, an ID, a component name, and a component version are associated with each other. In the example of FIG. 8, the ID is, for example, an identifier allocated to the component that is the target to be examined for the vulnerability. In the example of FIG. 8, the component name is, for example, a name of the component that is the target to be examined for the vulnerability. In addition, in the example of FIG. 8, the component version is, for example, a version of the component that is the target to be examined for the vulnerability. In the example of FIG. 8, target components whose IDs are 1 to 3 are components for which determination results are used to generate the difference information. In addition, in the example of FIG. 8, target components whose IDs are 4 and 5 are components which are determination targets for determining whether new examination is necessary.

The target determination unit 15 determines an information system including a component indicated by target component information based on configuration information and difference information. For example, the target determination unit 15 determines, based on the difference information, whether to present the information system including the component indicated by the target component information based on the configuration information. An information system that can be presented as the information system including the target component based on the configuration information is, for example, an information system that does not need to be examined as to whether the target component is included in the information system since whether the target component is included in the information system can be identified based on the configuration information. In addition, the target determination unit 15 may determine an information system that does not need to be examined as to whether the target component is included and an information system that needs to be examined.

For example, the target determination unit 15 determines, based on configuration information, difference information, and target determination result information in each information system, whether to present the information system including a target component based on the configuration information. For example, the target determination unit 15 collates the configuration information with the target component. For example, the target determination unit 15 collates a component included in the configuration information with the target component for each of the information systems. Collating means, for example, determining whether pieces of information match each other. For example, the target determination unit 15 determines whether the component included in the configuration information matches the target component for each of the information systems.

For example, for each of the information systems, the target determination unit 15 determines, based on the collation result between the component included in the configuration information and the target component and the difference information, whether it is possible to present that the target component is included based on the configuration information.

In a case where the number of responses for the determination target component in the difference information is less than a reference, the target determination unit 15 determines that it is an information system for which whether the target component is included cannot be presented based on the configuration information, for example. This is because there is a high possibility that an error occurs in information indicating whether the target component is included when whether the target component is included is presented based on the configuration information in the case where the number of responses for the determination target component in the difference information is less than the reference. In such a case, the target determination unit 15 determines, for example, an information system that is likely to include the target component as an information system that needs to be examined on the target component.

When the number of responses for the determination target component in the difference information is equal to or more than the reference, the target determination unit 15 determines, for example, whether an over-detection risk of the determination target component in the difference information is equal to or more than a reference. In addition, in a case where the number of responses for the determination target component in the difference information is equal to or more than the reference, the target determination unit 15 determines, for example, whether a detection miss risk of the determination target component in the difference information is equal to or more than a reference. Then, the target determination unit 15 determines if it is possible to present whether the information system includes the target component based on the configuration information, for example, based on presence or absence of a match between components, a determination result of the over-detection risk, and a determination result of the detection miss risk. That is, the target determination unit 15 determines whether it is necessary to examine the target component in the information system based on, for example, the presence or absence of the match between components, the determination result of the over-detection risk, and the determination result of the detection miss risk.

For example, in a case where the collation result is a mismatch and the detection miss risk is less than the reference, the target determination unit 15 determines that the target component has no influence on the information system. This is because there is a high possibility that the target component is not included in the information system as a determination target. In such a case, even when the over-detection risk is equal to or more than the reference, there is a low possibility that a mismatch occurs due to a detection miss, and there is a low possibility that the target component is included in the information system. Therefore, the target determination unit 15 determines, for example, that the information system as the determination target is an information system for which it can be presented that action for the target component is not required based on the configuration information. The fact that the action for the target component is not required means, for example, that examination for a vulnerability of the target component in the information system is unnecessary. The examination for the vulnerability of the target component is, for example, checking presence or absence of an influence of the target component on the information system. In addition, the examination for the vulnerability of the target component can include, for example, taking a measure against the vulnerability of the target component in the information system. The fact that the action for the target component is not required means that the measure in the information system is unnecessary since there is a high possibility that the target component is not included in the information system, for example, in a case where the target component has the vulnerability.

In addition, for example, in a case where the collation result is a mismatch and the detection miss risk is equal to or more than the reference, the target determination unit 15 determines that the influence of the target component is unknown. This is because there is a possibility that a detection miss occurs for the target component regardless of the fact that the target component is actually included in the information system in a case where the detection miss risk is high even though the collation result is a mismatch. In such a case, for example, the target determination unit 15 determines that the information system as the determination target is an information system for which whether the information system includes the target component cannot be presented based on the configuration information. That is, for example, the target determination unit 15 determines that the information system as the determination target is the information system for which examination on the target component is necessary. The necessity of examination on the target component means, for example, that it is necessary for an administrator of the information system to examine whether the target component is included in the information system.

In addition, the target determination unit 15 determines that the influence of the target component is present, for example, in a case where the collation result is a match and the over-detection risk is less than the reference. This is because the possibility of matching due to over-detection is low in a case where the collation result is a match and the over-detection risk is low. In addition, in such a case, even when the detection miss risk is equal to or more than the reference, the detection miss risk has no influence on the collation result, and there is a high possibility that the target component is included in the information system. Therefore, the target determination unit 15 determines, for example, that the information system as the determination target is an information system for which it can be presented that action for the target component is required based on the configuration information. The fact that the action for the target component is required means that it is necessary to take a measure against the vulnerability of the component in the information system since there is a high possibility that the target component is included in the information system, for example, in a case where the target component has the vulnerability.

In addition, for example, in a case where the collation result is a match and the over-detection risk is equal to or more than the reference, the target determination unit 15 determines that the influence of the target component is unknown. This is because there is a possibility that the target component is over-detected regardless of the fact that the target component is actually not included in the information system in a case where the over-detection risk is high even though the collation result is a match. In such a case, for example, the target determination unit 15 determines that the information system as the determination target is an information system for which whether the information system includes the target component cannot be presented based on the configuration information. That is, for example, the target determination unit 15 determines that the information system as the determination target is the information system for which examination on the target component is necessary.

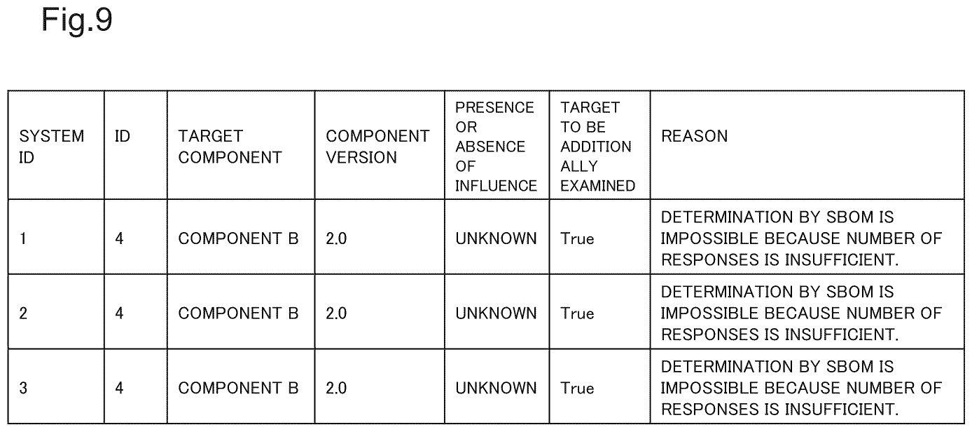

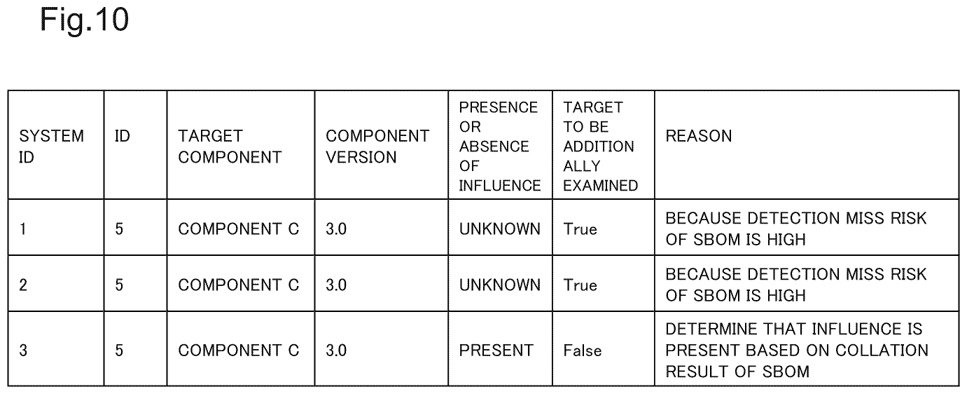

FIGS. 9 and 10 are examples of a determination result as to whether examination on a target component is necessary. The example of FIG. 9 is, for example, an example of the determination result on the necessity of examination on the target component whose ID is 4 in the example of FIG. 8. The example of FIG. 10 is, for example, an example of the determination result on the necessity of examination on the target component whose ID is 5 in the example of FIG. 8. In the examples of the determination result on the necessity of examination in FIGS. 9 and 10, a system ID, an ID, a target component, a component version, presence or absence of an influence, a target to be additionally examined, and a reason are associated with each other. In the examples of FIGS. 9 and 10, the system ID is, for example, an identifier of an information system. In the examples of FIGS. 9 and 10, the ID is, for example, an identifier of the target component. In the examples of FIGS. 9 and 10, the component version is, for example, a version of the target component.

In the examples of FIGS. 9 and 10, the presence or absence of the influence is, for example, presence or absence of an influence of a vulnerability of the target component on the information system. “Unknown” in an item of the presence or absence of the influence indicates, for example, that it is not possible to determine whether examination is necessary because the number of responses of the target component is small. “Present” in the item of the presence or absence of the influence indicates, for example, that it is determined that the vulnerability of the target component affects the information system. In addition, “Absent” in the item of the presence or absence of the influence indicates, for example, that it is determined that the vulnerability of the target component does not affect the information system.

In addition to the case where the number of responses of the target component is small, “Unknown” in the item of the presence or absence of the influence may also be indicated in other cases. For example, “Unknown” is indicated when the reason column in FIG. 10 shows “BECAUSE DETECTION MISS RISK OF SBOM IS HIGH.” Similarly, “Unknown” is also indicated when the reason column shows “BECAUSE OVER-DETECTION RISK OF SBOM IS HIGH.” In these cases, it is not possible to determine whether examination is necessary due to the high risk.

In the examples of FIGS. 9 and 10, the target to be additionally examined is, for example, information indicating whether examination on the target component is necessary in the information system. “True” in an item of the target to be additionally examined indicates that it is determined that the examination on the target component is necessary in the information system. “False” in the item of the target to be additionally examined indicates that it is determined that examination on the target component is unnecessary in the information system. In the examples of FIGS. 9 and 10, the reason is, for example, a reason for a determination result regarding the target to be additionally examined.

The output unit 16 outputs, for example, a determination result as to whether to present the information system including the target component based on the configuration information. The output unit 16 may output a determination result as to whether it is necessary to examine the target component in the information system.

The output unit 16 outputs, for example, to the terminal device 20, the determination result as to whether to present the information system including the target component based on the configuration information. In addition, the output unit 16 may output, to the terminal device 20, the determination result as to whether it is necessary to examine the target component in the information system.

The output unit 16 may output information indicating the component that needs to be examined to the administrator terminal device 30 used by an administrator who manages the information system for which examination on the target component is necessary. The output unit 16 may output information indicating a component that requires action against a vulnerability to the administrator terminal device 30 used by an administrator who manages an information system that requires action against the vulnerability of the target component.

The storage unit 17 stores, for example, data related to processing of determining whether to present the information system including the target component based on the configuration information. The storage unit 17 stores, for example, the determination result as to whether to present the information system including the target component based on the configuration information. The storage unit 17 stores, for example, the configuration information of each of the information systems. The storage unit 17 stores, for example, the determination result information. The storage unit 17 stores, for example, the difference information. The storage unit 17 stores, for example, the target component information.

The storage unit 17 may further include, for example, a configuration information storage unit 201, a determination result information storage unit 202, a difference information storage unit 203, and a target component information storage unit 204.

The configuration information storage unit 201 stores, for example, the configuration information as a configuration information database. The configuration information database is, for example, a database that stores information indicating a correspondence relationship between an information system and configuration information constituting the information system. For example, the configuration information acquisition unit 11 stores the acquired configuration information as the configuration information database in the configuration information storage unit 201, for example. For example, the generation unit 13 reads the configuration information related to the information system from the configuration information database of the configuration information storage unit 201.

The determination result information storage unit 202 stores, for example, the determination result information indicating a result of determining whether the component is included in the information system as a determination result information database. For example, the determination result information acquisition unit 12 stores the acquired determination result information in the determination result information storage unit 202 as the determination result information database. In addition, for example, the generation unit 13 reads the determination result information to be used to generate the difference information from the determination result information database of the determination result information storage unit 202. In addition, the target determination unit 15 reads, for example, from the determination result information database of the determination result information storage unit 202, the determination result information to be used to determine whether to present the information system including the component indicated by the target component information based on the configuration information.

The difference information storage unit 203 stores, for example, the difference information as a difference information database. The difference information database is, for example, a database that stores information indicating a correspondence relationship between a component and difference information. For example, the generation unit 13 stores the generated difference information in the difference information storage unit 203 as the difference information database. In addition, the target determination unit 15 reads the difference information from the difference information database of the difference information storage unit 203, for example.

The target component information storage unit 204 stores, for example, the target component information as a database. The target component information storage unit 204 stores, for example, the target component information acquired from the target component information acquisition unit 14 as a target component information database. In addition, the target determination unit 15 reads the target component information from the target component information database of the target component information storage unit 204, for example. The configuration information database, the determination result information database, the difference information database, and the target component information database may be stored in a storage unit outside the management support device 10.

Each processing in the management support device 10 may be executed in a plurality of information processing devices connected to each other via a network. For example, processing in the generation unit 13 and processing in the target determination unit 15 may be performed in different information processing devices. Which information processing device performs which processing in the management support device 10 can be set as appropriate for each processing.

The terminal device 20 is, for example, an information processing device used for processing in which a person in charge of providing information to an administrator of an information system provides information. The terminal device 20 is, for example, an information processing device used by a person in charge of providing vulnerability information for processing related to the provision of the vulnerability information. The person in charge of providing the vulnerability information is, for example, a person belonging to a product security incident response team (PSIRT).

For example, the terminal device 20 acquires, from the output unit 16 of the management support device 10, a determination result as to whether to present an information system including a target component based on configuration information. Then, the terminal device 20 outputs, for example, to a display device (not illustrated), the determination result as to whether to present the information system including the target component based on the configuration information.

The administrator terminal device 30 is, for example, an information processing device used by an administrator of an information system for managing the information system. For example, the administrator terminal device 30 acquires a result of determining a component constituting the information system input by an operation of the administrator. Then, for example, the administrator terminal device 30 outputs information regarding the result of determining the component constituting the information system to the determination result information acquisition unit 12 of the management support device 10 as determination result information. For example, the administrator of the information system inputs, to the administrator terminal device 30, a result of action for a component having a vulnerability acquired as target component information. Then, the administrator terminal device 30 outputs, for example, information regarding the result of action against the vulnerability to the determination result information acquisition unit 12 of the management support device 10 as the determination result information.

For example, the administrator terminal device 30 acquires, from the output unit 16 of the management support device 10, a determination result as to whether it is necessary to examine the target component in the information system. Then, the administrator terminal device 30 outputs, for example, to a display device (not illustrated), the determination result as to whether it is necessary to examine the target component in the information system. The administrator terminal device 30 may acquire, from the terminal device 20, the determination result as to whether it is necessary to examine the target component in the information system.

The provider terminal device 40 is, for example, an information processing device that provides information indicating a component that requires action as target component information. The provider terminal device 40 is, for example, an information processing device that provides vulnerability information of the component. The provider terminal device 40 acquires, for example, information indicating a component that requires action in an information system as the target component information. The target component information is input, for example, by an operation of a provider of the component. The provider terminal device 40 acquires, for example, information identifying a component having a vulnerability and content of the vulnerability as the target component information. Then, the provider terminal device 40 outputs the target component information to the target component information acquisition unit 14 of the management support device 10, for example.

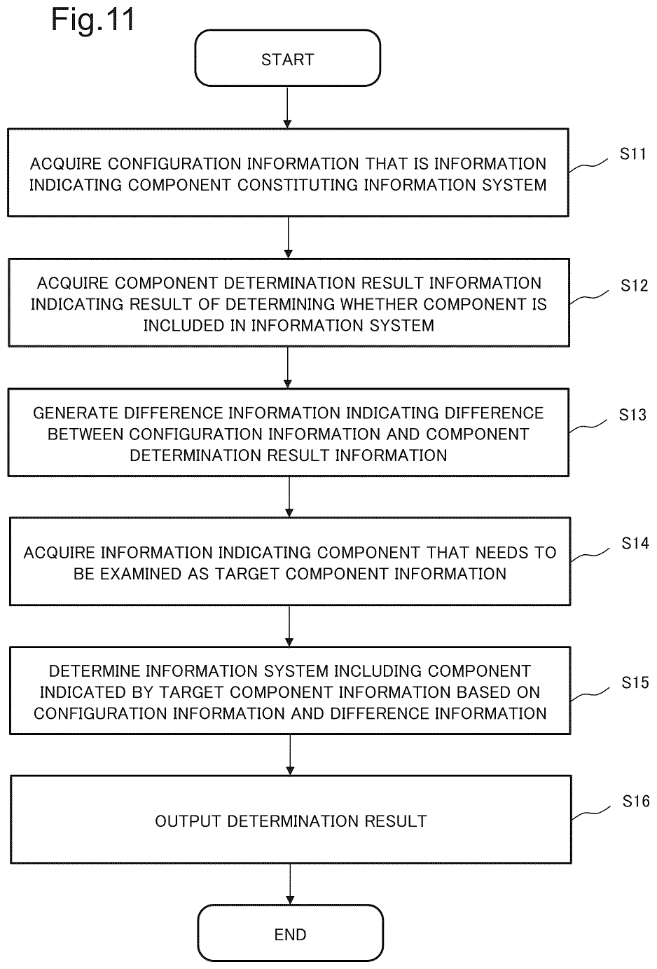

An example of an operation in processing in which the management support device 10 determines an information system including a component indicated by target component information will be described. FIG. 11 illustrates an example of an operation flow in the processing in which the management support device 10 determines an information system including a component indicated by target component information.

The configuration information acquisition unit 11 acquires configuration information that is information indicating a component constituting an information system (step S11).

In addition, the determination result information acquisition unit 12 acquires determination result information that is information regarding a result of determining the component constituting the information system in each of the information systems (step S12).

When the configuration information and the determination result information are acquired, the generation unit 13 generates difference information indicating a difference between the configuration information and the determination result information (step S13).

In addition, the target component information acquisition unit 14 acquires information indicating a component that needs to be examined as target component information (step S14).

When the target component information is acquired, the target determination unit 15 determines an information system including the component indicated by the target component information based on the configuration information and the difference information (step S15). For example, the target determination unit 15 determines whether to present the information system including the component indicated by the target component information based on the configuration information.

When the information system including the component indicated by the target component information is determined, the output unit 16 outputs, for example, the determination result of the information system including the component indicated by the target component information (step S16). The output unit 16 outputs, for example, the determination result as to whether to present the information system including the component indicated by the target component information based on the configuration information.

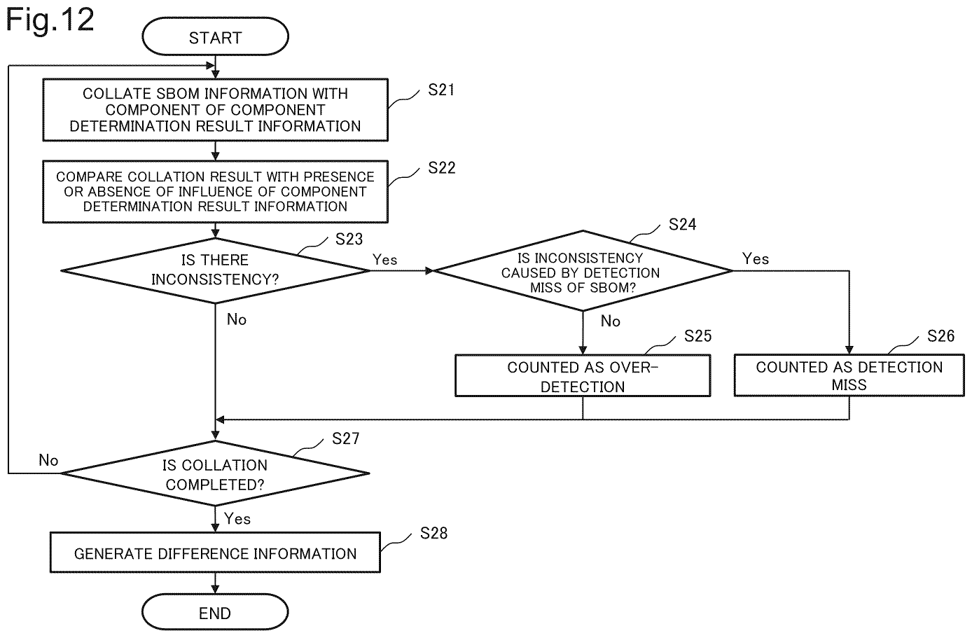

Processing in which the management support device 10 generates difference information will be described more specifically. FIG. 12 illustrates an example of an operation flow in the processing in which the management support device 10 generates difference information. In the following description, it is assumed that SBOM information that is information indicating a component constituting an information system by an SBOM is used as configuration information of the information system.

The generation unit 13 of the management support device 10 collates, for example, the SBOM information with determination result information (step S21). Collating the SBOM information with the determination result information means, for example, determining whether there is a match between the component included in the SBOM information and a component included in the determination result information.

When the SBOM information and the determination result information are collated, the generation unit 13 compares, for example, the collation result with data on presence or absence of an influence of the determination result information (step S22).

In the comparison in step S22, in a case where there is inconsistency between the collation result and the data on the presence or absence of the influence of the determination result information (Yes in step S23), in a case where a cause of the inconsistency is not a detection miss of the SBOM (No in step S24), the generation unit 13 counts this as the number of times of over-detection, for example (step S25). In a case where the collation between the SBOM information and the determination result information is not completed in a case where it is counted as the number of times of over-detection (No in step S27), the processing returns to step S21, and the generation unit 13 performs, for example, processing of collating the SBOM information with the determination result information.

In addition, in the comparison in step S22, in a case where there is inconsistency between the collation result and the data on the presence or absence of the influence of the determination result information (Yes in step S23), in a case where a cause of the inconsistency is a detection miss of the SBOM (Yes in step S24), the generation unit 13 counts this as the number of detection misses, for example (step S26). In a case where the collation between the SBOM information and the determination result information is not completed in a case where it is counted as the number of detection misses (No in step S27), the processing returns to step S21, and the generation unit 13 performs, for example, the processing of collating the SBOM information with the determination result information.

In addition, in step S27, in a case where the collation between the SBOM information and the determination result information is completed (Yes in step S27), the generation unit 13 calculates, for example, difference information based on the determination result (step S28). For example, the generation unit 13 calculates the over-detection risk and the detection miss risk as the difference information.

In addition, in step S23, in a case where there is no inconsistency between the collation result and the data on the presence or absence of the influence of the determination result information (No in step S23), in a case where the collation between the SBOM information and the determination result information is not completed (No in step S27), the processing returns to step S21, and the generation unit 13 performs, for example, the processing of collating the SBOM information with the determination result information.

In step S23, in a case where there is no inconsistency between the data of the collation result and the data on the presence or absence of the influence of the determination result information (No in step S23), in a case where the collation between the SBOM information and the determination result information is completed (Yes in step S27), the generation unit 13 generates difference information, for example, based on the determination result (step S28).

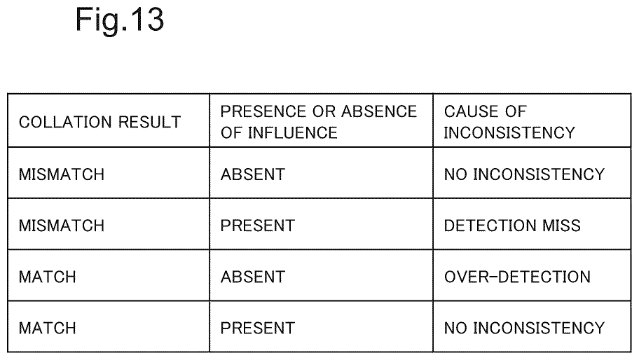

FIG. 13 is an example of a criterion for determining the presence or absence of the inconsistency between the collation result and the data on the presence or absence of the influence of the determination result information. In the example of FIG. 13, the collation result is associated with the presence or absence of the influence and the cause of the inconsistency. In a case where the influence is present in a case where the collation result is a mismatch, the generation unit 13 determines that a detection miss has occurred, for example. The presence of the influence in a case where the collation result is a mismatch is caused because the information system is affected by the target component not included in the SBOM. Alternatively, the presence of the influence in a case where the collation result is a mismatch is caused because the information system includes the target component not included in the SBOM. In a case where the influence is absent in a case where the collation result is a match, the generation unit 13 determines that over-detection has occurred, for example. The absence of the influence in a case where the collation result is a match is caused because the target component included in the SBOM does not exist in the information system.

In a case where the influence is absent in a case where the collation result is a mismatch, the generation unit 13 determines, for example, that there is no inconsistency. The absence of the influence in a case where the collation result is a mismatch is caused because the target component is not included in the SBOM and does not exist in the information system, and thus cannot have any influence. In a case where the influence is present in a case where the collation result is a match, the generation unit 13 determines, for example, that there is no inconsistency. The presence of the influence in a case where the collation result is a match is caused because the target component is included in the SBOM, and the target component also exists in the information system.

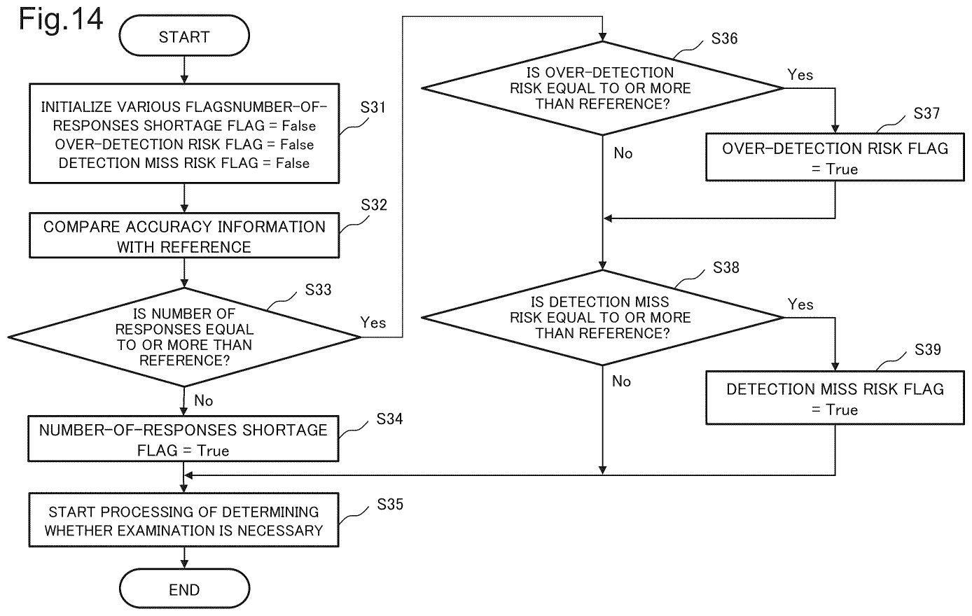

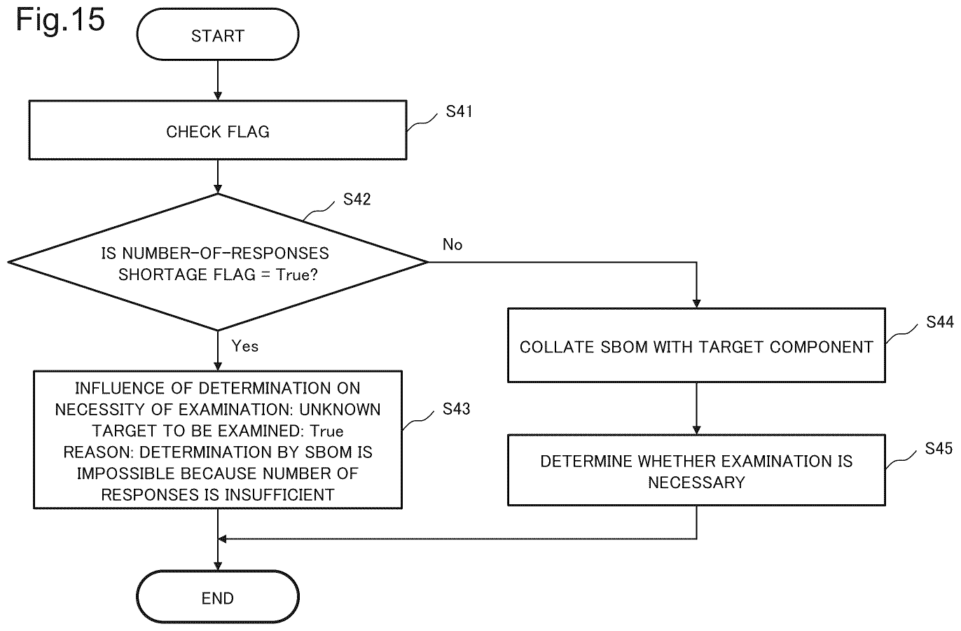

A specific example of processing in which the management support device 10 determines whether it is necessary to examine a target component in an information system will be described. FIGS. 14 and 15 illustrate examples of an operation flow in the processing in which the management support device 10 determines whether it is necessary to examine the target component.

In the example of FIG. 14, for example, the target determination unit 15 initializes flags related to the processing of determining whether it is necessary to examine the target component (step S31). The target determination unit 15 initializes a number-of-responses shortage flag, an over-detection risk flag, and a detection miss flag by setting them to “False”, for example.

When the flags are initialized, the target determination unit 15 compares, for example, difference information with a reference for determining whether a target is to be examined (step S32). The reference for determining whether the target is to be examined is set for each of the number of responses, the over-detection risk, and the detection miss risk.

In a case where the number of responses is less than the reference in the comparison in step S32 (No in step S33), the target determination unit 15 sets the number-of-responses shortage flag to “True”, for example (step S34). When the number-of-responses shortage flag is set, the target determination unit 15 starts, for example, the processing of determining whether the examination is necessary (step S35).

In a case where the number of responses is equal to or more than the reference in the comparison in step S32 (Yes in step S33), the target determination unit 15 determines, for example, whether the over-detection risk is equal to or more than the reference. In a case where the over-detection risk is equal to or more than the reference (Yes in step S36), the target determination unit 15 sets the over-detection risk flag to “True”, for example (step S37).

In step S36, in a case where the over-detection risk is less than the reference (No in step S36), or in a case where the over-detection risk flag has been set in step S37, the target determination unit 15 determines, for example, whether the detection miss risk is equal to or more than the reference. In a case where the detection miss risk is equal to or more than the reference (Yes in step S38), the target determination unit 15 sets the detection miss risk flag to “True”, for example (step S39).

In a case where the detection miss risk is less than the reference in step S38 (No in step S38) or in a case where the detection miss risk flag has been set in step S39, the target determination unit 15 starts, for example, the processing of determining whether examination is necessary (step S35).

When the processing of determining whether examination is necessary is started in step S35 of FIG. 14, in step S41 of FIG. 15, the target determination unit 15 checks, for example, a flag set for the target component (step S41).

In a case where the setting of the number-of-responses shortage flag is “True” (Yes in step S42), for example, the target determination unit 15 determines that examination in the information system is necessary, and sets a flag of a target to be examined to “True” (step S43). The target determination unit 15 determines that an influence is unknown and the examination is necessary in the information system because the determination by the SBOM is impossible due to the number of responses is insufficient.

In a case where the setting of the number-of-responses shortage flag is “False” (No in step S42), the target determination unit 15 collates the target component with, for example, the SBOM related to the information system (step S44). Then, for example, the target determination unit 15 determines the necessity regarding the target component in the information system (step S45). The necessity is, for example, a necessity of examination.

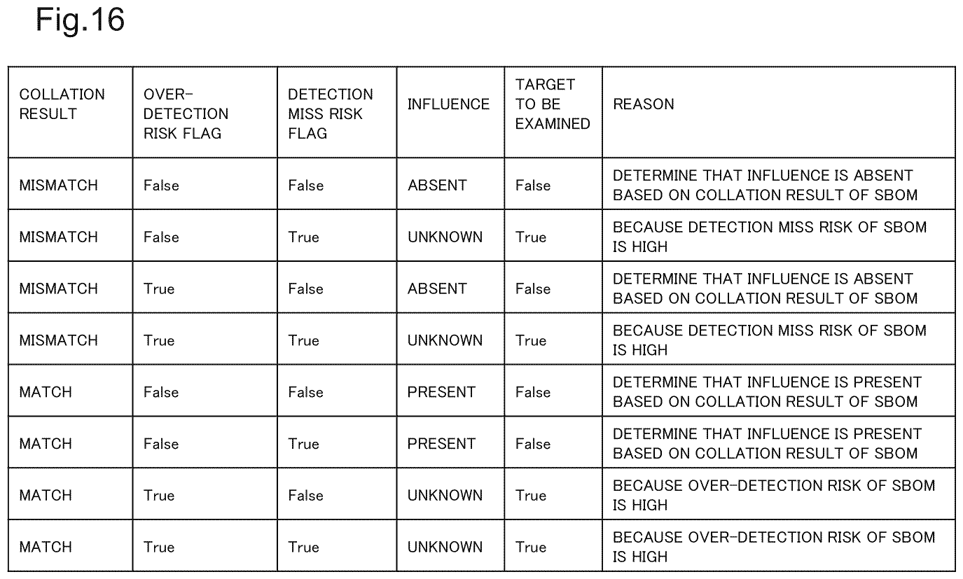

FIG. 16 is a table illustrating a correspondence relationship between the collation result and the difference information, and the necessity of examination. In an example of the table of FIG. 16, the collation result, the over-detection risk flag, the detection miss risk flag, an influence, a target to be examined, and a reason are associated with each other. In the example of the table of FIG. 16, the influence is, for example, information indicating presence or absence of an influence of the target component with respect to the information system, which is estimated from the collation result, the over-detection risk flag, and the detection miss risk flag. In addition, in the example of the table in FIG. 16, the target to be examined indicates, for example, a determination result as to whether examination on the target component is necessary in the information system. In the example of the table in FIG. 16, “True” in an item of the target to be examined indicates, for example, that the examination on the target component is necessary in the information system. In the example of the table in FIG. 16, “False” in the item of the target to be examined indicates, for example, that the examination on the target component is unnecessary in the information system.

In the example of the table of FIG. 16, “Absent” in an item of the influence indicates that it can be determined that the influence is absent based on, for example, information of the SBOM related to the information system. Therefore, in the example of the table in FIG. 16, the examination is unnecessary, for example, in a case where the item of the influence is “Absent”, and thus the item of the target to be examined is set to “False”. In the example of the table of FIG. 16, “Present” in the item of the influence indicates that it can be determined that the influence is present based on, for example, the information of the SBOM related to the information system. Therefore, in the example of the table in FIG. 16, the examination is unnecessary, for example, in a case where the item of the influence is “Present”, and thus the item of the target to be examined is set to “False”. In addition, in the example of the table of FIG. 16, “Unknown” in the item of the influence indicates that the presence or absence of the influence cannot be determined from, for example, the information of the SBOM related to the information system, and thus the examination is necessary. In the example of the table in FIG. 16, for example, in a case where the item of the influence is “Unknown”, the examination is necessary, and thus the item of the target to be examined is set to “True”. In addition, in the example of the table of FIG. 16, the reason indicates, for example, a reason for determination as to whether the target is to be examined.

The target determination unit 15 determines whether to present the information system including the target component based on the configuration information with reference to, for example, the table illustrated in the example of FIG. 16. For example, the target determination unit 15 determines whether the examination on the target component is necessary in the information system with reference to the table illustrated in the example of FIG. 16, thereby determining whether to present the information system including the target component based on the configuration information. The target determination unit 15 refers to, for example, the table illustrated in the example of FIG. 16, and checks the flag of the target to be examined associated with the collation result, the over-detection risk flag, and the detection miss risk flag. Then, the target determination unit 15 determines whether the examination on the target component in the information system is necessary based on the flag of the target to be examined.

The management support device 10 generates the difference information indicating the difference between the configuration information that is information indicating the component constituting the information system and the determination result information indicating the result of determination as to whether the component is included in the information system. In addition, the management support device 10 acquires, as the target component information, information indicating the component that needs to be examined for the vulnerability. Then, the management support device 10 determines, based on the difference information, whether to present the information system including the component indicated by the target component information based on the configuration information. Since whether to present the information system including the component indicated by the target component information based on the configuration information is determined in this manner, the management support device 10 can improve the accuracy of determining the target to be examined even when the configuration information is inaccurate.

Since whether to present the information system including the component indicated by the target component information based on the configuration information is determined, for example, based on the difference information including the over-detection risk and the detection miss risk, the management support device 10 can determine whether to use the configuration information based on the likelihood of the configuration information. Therefore, the management support device 10 can further improve the accuracy of determining the target to be examined in a case where the configuration information is inaccurate.

In addition, for example, since the difference information is generated based on the result of the examination for the vulnerability of the component performed by the administrator of the information system, the management support device 10 can accurately determine whether to present the information system including the component indicated by the target component information based on the configuration information without requiring additional work of the administrator of the information system, for example. Therefore, the management support device 10 can efficiently improve the accuracy of determining the target to be examined in a case where the configuration information is inaccurate.

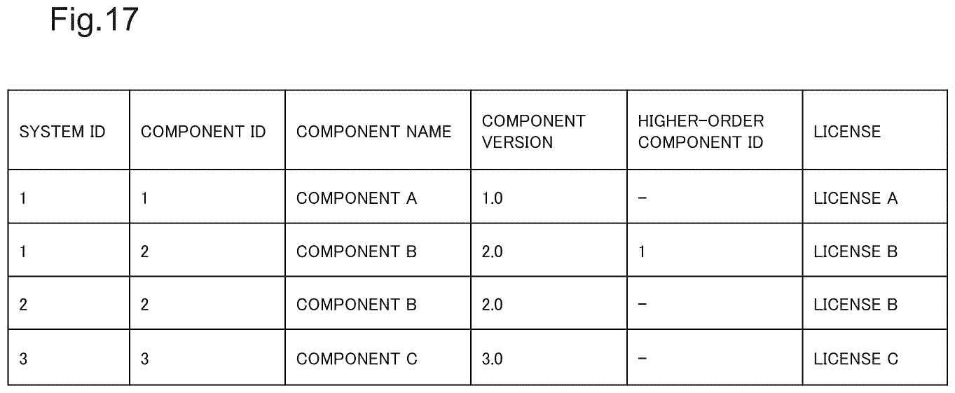

The management support device 10 may be used for license management of a component. FIG. 17 is an example of configuration information in a case where the license management is performed. In the example of the configuration information of FIG. 17, a system ID, a component ID, a component name, a component version, a higher-order component ID, and a license are associated with each other. For example, the management support device 10 acquires, as target component information, information indicating a component that needs to be examined for the license. Then, for example, the management support device 10 determines whether to present an information system including the component that needs to be examined for the license and is indicated by the target component information based on the configuration information.

In the example of the configuration information of FIG. 17, the system ID is, for example, an identifier allocated to the information system. In the example of the configuration information of FIG. 17, the component ID is, for example, an identifier allocated to the component. In the example of the configuration information of FIG. 17, the component name is, for example, a name of the component. In the example of the configuration information of FIG. 17, the component version is, for example, a version of the component. In the example of the configuration information of FIG. 17, the higher-order component ID is, for example, an identifier of a higher-order component. In the example of the configuration information of FIG. 17, the license is, for example, information regarding a license for permitting use of the component.

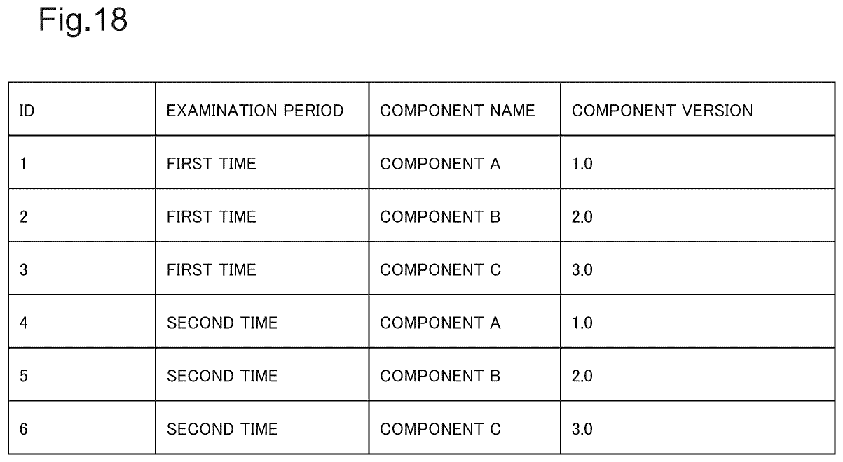

In addition, FIG. 18 is an example of the target component information indicating the component that is a target to be examined for the license. In the example of FIG. 18, an ID, an examination period, a component name, and a component version are associated with each other. In the example of FIG. 18, the ID is, for example, an identifier of a target component that is a target to be examined. In the example of FIG. 18, the examination period is, for example, information indicating a period of time in which examination has been performed. In the example of FIG. 18, the component name is, for example, a name of the component that is the target to be examined. In the example of FIG. 18, the component version is, for example, a version of the component that is the target to be examined.

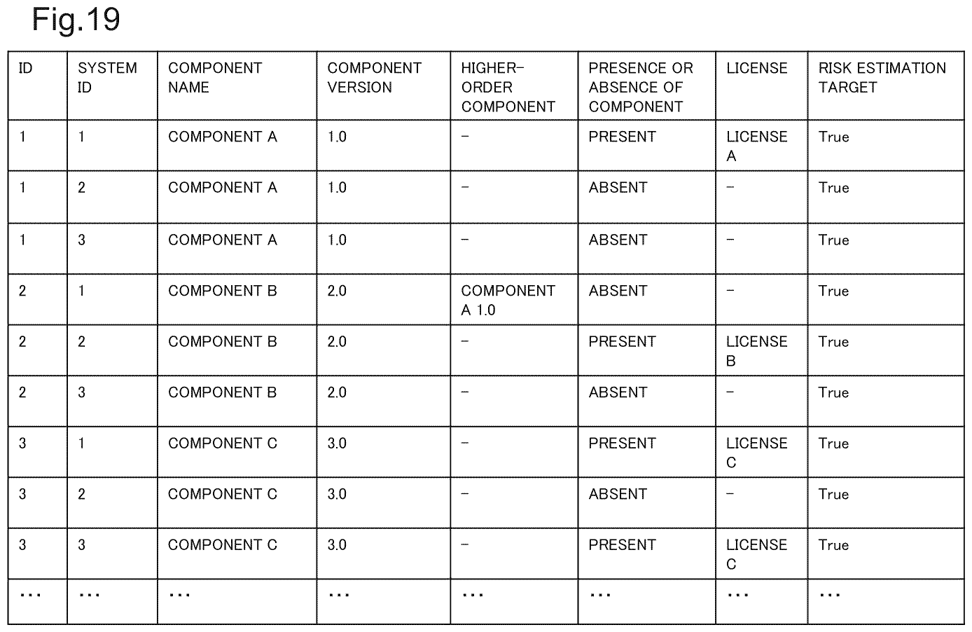

FIG. 19 illustrates determination result information regarding the component that is the target to be examined for the license. In the example of FIG. 19, an ID, a system ID, a component name, a component version, a higher-order component, presence or absence of a component, a license, and a risk estimation target are associated with each other.

In the example of FIG. 19, the ID is, for example, an identifier allocated to each component to be licensed. In the example of FIG. 19, the system ID is, for example, an identifier allocated to an information system. In the example of FIG. 19, the component ID is, for example, an identifier allocated to the component. In the example of FIG. 19, the component name is, for example, a name of the component. In the example of FIG. 19, the component version is, for example, a version of the component. In the example of FIG. 19, the higher-order component is, for example, a name and a version of a higher-order component. In the example of FIG. 19, the presence or absence of the component is, for example, a result of determination on presence or absence of the component in the information system by an administrator of the information system. In the example of FIG. 19, for example, the license is, for example, a license being held. In addition, in the example of FIG. 19, the risk estimation target indicates, for example, whether data is a target of risk estimation in generation of difference information. In the example of FIG. 19, the fact that an item of the risk estimation target is “True” indicates, for example, that data is the target of risk estimation in the generation of difference information. In the example of FIG. 19, in a case where the item of the risk estimation target is “False”, it indicates that the data is not data as the target of risk estimation in the generation of difference information.

The management support device 10 generates difference information based on, for example, the configuration information illustrated in the example of FIG. 18 and the determination result information illustrated in the example of FIG. 19. Then, for example, based on the difference information, the management support device 10 determines whether to present the information system including the component that needs to be examined for the license and is indicated by the target component information based on the configuration information. Since whether to present the information system including the component that needs to be examined for the license based on the configuration information is determined in this manner, the management support device 10 can improve accuracy of determining the target to be examined for the license of the component even when the configuration information is inaccurate, for example.

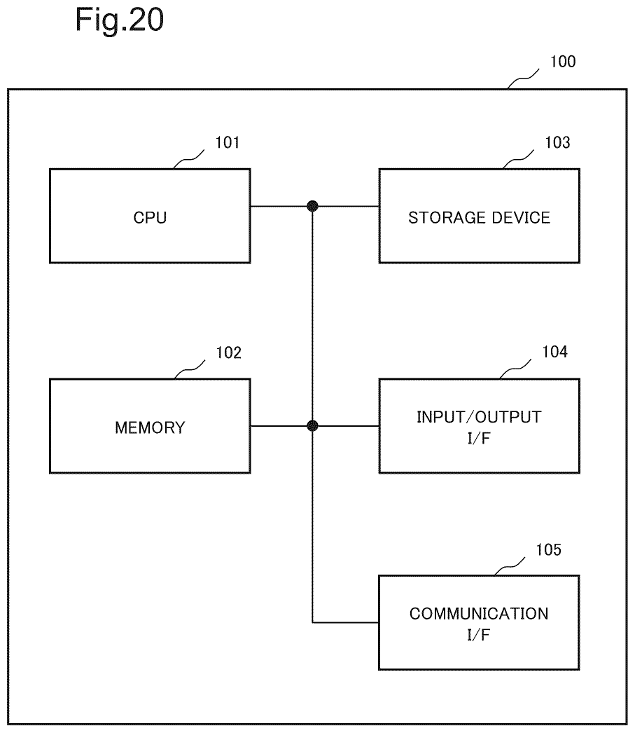

Each processing in the management support device 10 can be enabled by executing a computer program on a computer. FIG. 20 illustrates an example of a configuration of a computer 100 that executes a computer program for performing each processing in the management support device 10. The computer 100 includes a central processing unit (CPU) 101, a memory 102, a storage device 103, an input/output interface (I/F) 104, and a communication I/F 105.

The CPU 101 reads and executes a computer program for performing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a graphics processing unit (GPU). The memory 102 includes a dynamic random access memory (DRAM) or the like, and temporarily stores a computer program executed by the CPU 101 and data being processed. The storage device 103 stores the computer program executed by the CPU 101. The storage device 103 includes, for example, a non-volatile semiconductor storage device. The storage device 103 may include another storage device such as a hard disk drive. The input/output I/F 104 is an interface that receives an input from an operator and outputs display data and the like. The communication I/F 105 is an interface that transmits and receives data to and from the terminal device 20, the administrator terminal device 30, and the provider terminal device 40. The terminal device 20, the administrator terminal device 30, and the provider terminal device 40 may have configurations similar to those of the computer 100.

The computer program used for executing each processing can also be distributed by being stored in a computer-readable recording medium that non-transiently records data. As the recording medium, for example, a magnetic tape for data recording or a magnetic disk such as a hard disk can be used. As the recording medium, an optical disk such as a compact disc read only memory (CD-ROM) can also be used. A non-volatile semiconductor storage device may be used as the recording medium.

An information system is managed, for example, by registering a component constituting the information system as configuration information. For example, in a case where a vulnerability is found in a component, an information system in which the component in which the vulnerability is found is being used is identified with reference to the configuration information. In addition, an information system may be used to identify the information system that requires action against the vulnerability of the component.

A vulnerability management system of JP 2020-21309 A generates information indicating a product that is a target to be examined for an influence of a vulnerability of software based on a database that collects configuration information of the software included in the product. Then, the vulnerability management system of JP 2020-21309 A examines the influence of the vulnerability of software in the target product.

In the technique described in JP 2020-21309 A, in a case where the configuration information is inaccurate, it may be difficult to accurately determine the target to be examined.

In order to solve the above problem, an object of the present disclosure is to provide a management support device and the like capable of improving accuracy of determining a target to be examined even when configuration information is inaccurate.

According to the present disclosure, the accuracy of determining the target to be examined can be improved even when the configuration information is inaccurate.

Some or all of the above example embodiments may be described as the following Supplementary Notes, but are not limited to the following.

### [Supplementary Note 1]

A management support device including:
a generation unit configured to generate difference information indicating a difference between configuration information that is information indicating a component constituting an information system and determination result information indicating a result of determining whether the component is included in the information system;
a target component information acquisition unit configured to acquire information indicating a component that needs to be examined as target component information; and
a target determination unit configured to determine the information system including the component indicated by the target component information based on the configuration information and the difference information.

### [Supplementary Note 2]

The management support device according to Supplementary Note 1, wherein
the target determination unit determines an information system that needs to be examined as to whether the component indicated by the target component information is included. [Supplementary Note 3]

The management support device according to Supplementary Note 1, wherein
the determination result information is a result of examining a vulnerability of the component in the information system, and
the target component information acquisition unit acquires, as the target component information, information indicating a component that needs to be examined for the vulnerability.

### [Supplementary Note 4]

The management support device according to Supplementary Note 3, wherein
the generation unit generates, as the difference information, information regarding the number of pieces of data of over-detection and the number of pieces of data of a detection miss of the component that needs to be examined for the vulnerability, the over-detection and the detection miss occurring when whether the information system includes the component that needs to be examined for the vulnerability is identified with reference to the configuration information.

### [Supplementary Note 5]

The management support device according to Supplementary Note 4, wherein
the target determination unit determines an information system that needs to be examined as to whether the component indicated by the target component information is included based on the difference information and a collation result between the configuration information and the target component information in a case where the number of pieces of data obtained by performing the identification is equal to or more than a reference.

### [Supplementary Note 6]

The management support device according to Supplementary Note 5, wherein
in a case where the number of pieces of data of the detection miss is equal to or more than a reference in a case where the configuration information and the target component information do not match each other in the collation result, the target determination unit determines that the information system needs to be examined as to whether the component indicated by the target component information is included.

### [Supplementary Note 7]

The management support device according to Supplementary Note 5, wherein
in a case where the number of pieces of data of the over-detection is equal to or more than a reference in a case where the configuration information and the target component information match each other in the collation result, the target determination unit determines that the information system needs to be examined as to whether the component indicated by the target component information is included.

### [Supplementary Note 8]

The management support device according to any one of Supplementary Notes 4 to 7, wherein
the target determination unit determines presence or absence of an influence of the component indicated by the target component information with respect to the information system based on the configuration information in a case where the number of pieces of data obtained by performing the identification is equal to or more than a reference and the number of pieces of data of the over-detection and the number of pieces of data of the detection miss are less than references.

### [Supplementary Note 9]

The management support device according to Supplementary Note 5, wherein
the target determination unit determines that the component indicated by the target component information has no influence on the information system in a case where the number of pieces of data of the detection miss is less than a reference in a case where the configuration information and the target component information do not match each other in the collation result.

### [Supplementary Note 10]

The management support device according to Supplementary Note 5, wherein
the target determination unit determines that the component indicated by the target component information has an influence on the information system in a case where the number of pieces of data of the over-detection is less than a reference in a case where the configuration information and the target component information match each other in the collation result.

### [Supplementary Note 11]

The management support device according to Supplementary Note 6 or 7, further including
an acquisition unit configured to acquire at least one of a reference of the number of pieces of data of the over-detection and the reference of the number of pieces of data of the detection miss to be used for determination of a target of the examination, wherein
the target determination unit determines the target of the examination for the vulnerability based on the acquired reference. [Supplementary Note 12]

The management support device according to any one of Supplementary Notes 1 to 7, further including:
a configuration information acquisition unit configured to acquire the configuration information and store the configuration information in a configuration information database; and
a determination result information acquisition unit configured to acquire the determination result information and store the determination result information in a determination result information database, wherein
the generation unit generates the difference information based on the configuration information read from the configuration information database and the determination result information read from the determination result information database.

### [Supplementary Note 13]

The management support device according to Supplementary Note 12, wherein
the generation unit stores the generated difference information in a difference information database, and
the target determination unit determines whether the component indicated by the target component information is set as a target to be examined in the information system based on the difference information read from the difference information database.

### [Supplementary Note 14]

A management support method including:
generating difference information indicating a difference between configuration information that is information indicating a component constituting an information system and determination result information indicating a result of determining whether the component is included in the information system;
acquiring information indicating a component that needs to be examined as target component information; and
determining the information system including the component indicated by the target component information based on the configuration information and the difference information.

### [Supplementary Note 15]

A non-transitory recording medium recording a program for causing a computer to execute:
processing of generating difference information indicating a difference between configuration information that is information indicating a component constituting an information system and determination result information indicating a result of determining whether the component is included in the information system;
processing of acquiring information indicating a component that needs to be examined as target component information; and
processing of determining the information system including the component indicated by the target component information based on the configuration information and the difference information.

Some or all of the configurations described in Supplementary Notes 2 to 13 subordinate to above-described Supplementary Note 1 can also be subordinate to Supplementary Notes 14 and 15 with a subordinate relationship similar to that of Supplementary Notes 2 to 13. Some or all of the configurations described as the Supplementary Notes can be similarly subordinate to not only the Supplementary Notes 1, 14, and 15, but also various pieces of hardware and software, a variety of recording means for recording software, and systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A management support device comprising:
at least one memory storing instructions; and
at least one processor configured to access the at least one memory and execute the instructions to:
generate difference information indicating a difference between configuration information that is information indicating a component constituting an information system and determination result information indicating a result of determining whether the component is included in the information system;
acquire information indicating a component that needs to be examined as target component information; and
determine the information system including the component indicated by the target component information based on the configuration information and the difference information.

2. The management support device according to claim 1, wherein
the at least one processor is further configured to execute the instructions to: determine, based on the difference information, an information system that needs to be examined as to whether the component indicated by the target component information is included.

3. The management support device according to claim 1, wherein
the determination result information is a result of examining a vulnerability of the component in the information system, and
the at least one processor is further configured to execute the instructions to:
acquire, as the target component information, information indicating a component that requires action against the vulnerability.

4. The management support device according to claim 3, wherein
the at least one processor is further configured to execute the instructions to:
generate, as the difference information, information regarding a number of pieces of data of over-detection and a number of pieces of data of a detection miss of the component that requires the action against the vulnerability, the over-detection and the detection miss occurring in a case where whether the information system includes the component that requires the action against the vulnerability is identified with reference to the configuration information.

5. The management support device according to claim 4, wherein
the at least one processor is further configured to execute the instructions to: determine an information system that needs to be examined as to whether the component indicated by the target component information is included based on the difference information and a collation result between the configuration information and the target component information in a case where a number of pieces of data obtained by performing the identification is equal to or more than a reference.

6. The management support device according to claim 5, wherein
the at least one processor is further configured to execute the instructions to:
in a case where the number of pieces of data of the detection miss is equal to or more than a reference in a case where the configuration information and the target component information do not match each other in the collation result, determine that the information system needs to be examined as to whether the component indicated by the target component information is included.

7. The management support device according to claim 5, wherein
the at least one processor is further configured to execute the instructions to:
in a case where the number of pieces of data of the over-detection is equal to or more than a reference in a case where the configuration information and the target component information match each other in the collation result, determines that the information system needs to be examined as to whether the component indicated by the target component information is included.

8. The management support device according to claim 4, wherein
the at least one processor is further configured to execute the instructions to:
determine presence or absence of an influence of the component indicated by the target component information with respect to the information system based on the configuration information in a case where a number of pieces of data obtained by performing the identification is equal to or more than a reference and the number of pieces of data of the over-detection and the number of pieces of data of the detection miss are less than references.

9. The management support device according to claim 5, wherein
the at least one processor is further configured to execute the instructions to:
determine that the component indicated by the target component information has no influence on the information system in a case where the number of pieces of data of the detection miss is less than a reference in a case where the configuration information and the target component information do not match each other in the collation result.

10. The management support device according to claim 5, wherein
the at least one processor is further configured to execute the instructions to:
determine that the component indicated by the target component information has an influence on the information system in a case where the number of pieces of data of the over-detection is less than a reference in a case where the configuration information and the target component information match each other in the collation result.

11. The management support device according to claim 6, wherein
the at least one processor is further configured to execute the instructions to:
acquire at least one of a reference of the number of pieces of data of the over-detection and the reference of the number of pieces of data of the detection miss to be used for determination of a target of the examination; and
determine the target of the examination for the vulnerability based on the acquired reference.

12. The management support device according to claim 1, wherein
the at least one processor is further configured to execute the instructions to: acquire the configuration information and store the configuration information in a configuration information database;
acquire the determination result information and store the determination result information in a determination result information database; and
generate the difference information based on the configuration information read from the configuration information database and the determination result information read from the determination result information database.

13. The management support device according to claim 12, wherein
the at least one processor is further configured to execute the instructions to:
store the generated difference information in a difference information database; and
determine whether the component indicated by the target component information is set as a target to be examined in the information system based on the difference information read from the difference information database.

14. A management support method comprising:
generating difference information indicating a difference between configuration information that is information indicating a component constituting an information system and determination result information indicating a result of determining whether the component is included in the information system;
acquiring information indicating a component that needs to be examined as target component information; and
determining the information system including the component indicated by the target component information based on the configuration information and the difference information.

15. A non-transitory recording medium recording a program for causing a computer to execute:
processing of generating difference information indicating a difference between configuration information that is information indicating a component constituting an information system and determination result information indicating a result of determining whether the component is included in the information system;
processing of acquiring information indicating a component that needs to be examined as target component information; and
processing of determining the information system including the component indicated by the target component information based on the configuration information and the difference information.
